(19) United States
(12) Patent Application Publication
(10) Pub. No.: US 2008/0162709 A1
(43) Pub. Date: Jul. 3, 2008

(54) SYSTEM FOR PROCESSING APPLICATION PROTOCOL REQUESTS

(75) Inventors: CURTIS E. HRISCHUK, Holly Springs, NC (US); Gary J. Deval, Raleigh, NC (US); Michael J. Spreitzer, Croton on Hudson, NY (US); Jin Feng Hu, Beijing (CN)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, Armonk, NY (US)

(21) Appl. No.: 11/616,525

(22) Filed: Dec. 27, 2006

(51) Int. Cl. G06F 15/16

(52) U.S. Cl. 709/230

(57) ABSTRACT

A system for processing application protocol requests is disclosed. An apparatus that incorporates teachings of the present disclosure may include, for example, an Application Protocol Assignment System having a controller element that assigns each of one or more application protocol requests to a select one or more of a plurality of application servers according to a memory utilization of each of the plurality of application servers. Additional embodiments are disclosed.

### FIELD OF THE INVENTION

The present disclosure relates generally to signaling systems, and more specifically to a system for processing application protocol requests.

### BACKGROUND

In an IP network utilizing any number of application protocols such as the Session Initiation Protocol (SIP) and/or the Hyper Text Transfer Protocol (HTTP) for establishing communication services, network elements operating in said IP network can experience a resource fault or excessive latency in establishing a requested service when processing resources are improperly managed.

A need therefore arises for a system for processing application protocol requests in IP networks.

### BRIEF DESCRIPTION OF THE DRAWINGS

FIG. 1 depicts an exemplary embodiment of a communication system;

FIG. 2 depicts exemplary embodiments of an Application Protocol Assignment System (APAS) of the communication system that manages application protocol processing on one or more application nodes of the communication system;

FIG. 3 depicts an exemplary method operating in portions of the communication system; and

FIG. 4 depicts an exemplary diagrammatic representation of a machine in the form of a computer system within which a set of instructions, when executed, may cause the machine to perform any one or more of the methodologies disclosed herein.

### DETAILED DESCRIPTION OF THE DRAWINGS

Embodiments in accordance with the present disclosure provide a system for processing application protocol requests.

In a first embodiment of the present disclosure, a computer-readable storage medium in an Application Protocol Assignment System (APAS) can have computer instructions for determining a memory utilization for each of a plurality of application servers, receiving one or more application protocol requests, and assigning each of the one or more application protocol requests to a select one or more of the plurality of application servers according to their respective memory utilization.

In a second embodiment of the present disclosure, an APAS can have a controller element that assigns each of one or more application protocol requests to a select one or more of a plurality of application servers according to a memory utilization of each of the plurality of application servers.

In a third embodiment of the present disclosure, a processing node can have a controller element that assigns one or more application protocol requests to one or more application servers according to a memory utilization determination for each of the one or more application servers.

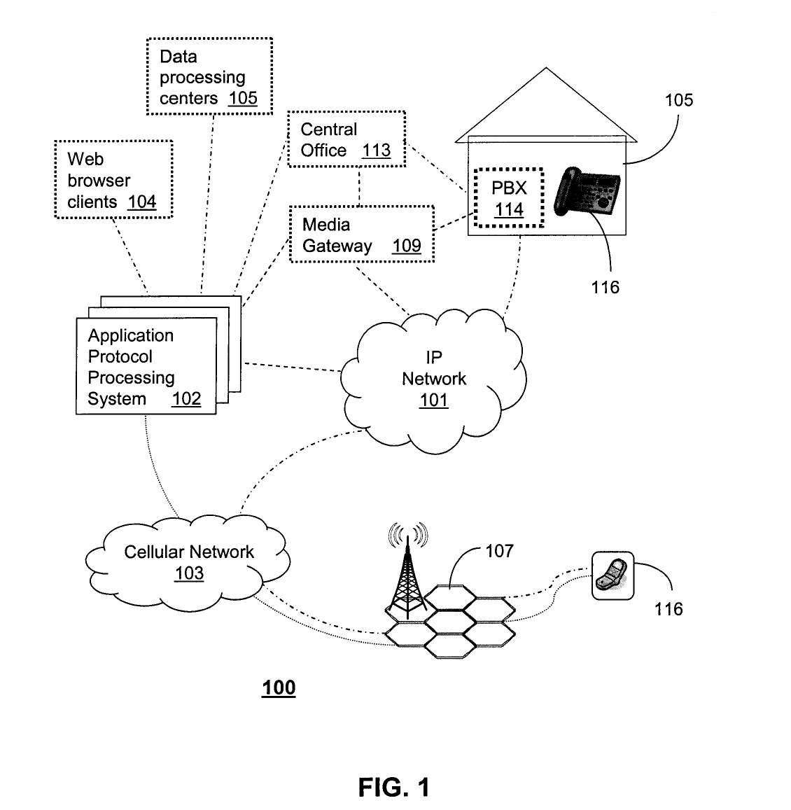

FIG. 1 depicts an exemplary embodiment of a communication system 100. The communication system 100 can comprise an IP (Internet Protocol) network 101 coupled to one or more Application Protocol Processing Systems (APPSs) 102, a cellular network 103 and network elements located in a building 105 representing an enterprise or residence. The IP network 101 can utilize common packet-switched routing technology for transporting data traffic. In an enterprise setting, the building 105 can include a PBX 114 or other suitable coupling interface to the IP network 101 (e.g., xDSL, Cable, satellite, etc.) that provides voice, video or data services to terminal devices 116.

The terminal devices 116 can be fixed or mobile devices as shown in FIG. 1. Additionally, such devices 116 can be utilized for POTS (Plain Old Telephone Service), Voice over IP (VoIP), video, presence and/or instant messaging services. In a residential setting, the building 105 can include POTS, VoIP or video phone terminals coupled to the IP network 101 by way of a central office 113 that utilizes common telephonic switching technology for processing calls with third parties or other coupling interfaces such as those mentioned above.

Communications between the APPS 102, the terminal devices 116 and other network elements (e.g., common routers, common switches, etc.) of the communication system 100 can conform to any number of signaling protocols such as signaling system 7 (SS7), session initiation protocol (SIP), H.323 and combinations thereof. The APPS 102 can direct by common means any of the network elements of the communication system 100 to establish packet switched connections and in some instances hybrid connections including circuit-switched paths between terminals devices 116 distributed throughout the communication system 100.

The APPS 102 can utilize computing technology such as a desktop computer, or scalable computing hardware for performing the tasks described herein. The APPS 102 can operate in whole or in part as an IP Multimedia Subsystem (IMS) conforming in part to protocols defined by standards bodies such as 3GPP (Third Generation Partnership Project). Under the control of the APPS 102, a media gateway 109 can link packet-switched and circuit-switched technologies such as the cellular network 103 or central office 113 to the IP network 101, and vice-versa.

The media gateway 109 can conform to a proprietary media gateway control protocol (MGCP) or an open standard such as H.248 defined in the Internet Engineering Task Force (IETF). This protocol can handle signaling and session management needed during a multimedia conference. The protocol defines a means of communication between the media gateway 109, which converts data from the format required for a circuit-switched network to that required for a packet-switched network. MGCP can therefore be used to set up, maintain, and terminate calls between disparate circuit-switched and packet-switched network elements of the communication system 100. The media gateway 109 can therefore support hybrid communication environments such as VoIP (or IP video) to POTS and vice-versa.

The cellular network 103 can support voice and data services such as GSM-GPRS, EDGE, CDMA-1X, UMTS, and other known technologies. The IP Network 101 can have a number of common packet-switched routing elements for transporting real-time data traffic (e.g., VoIP) as well as non real-time data traffic (e.g., Internet browsing).

The APPS 102 can also be utilized in non-telephony protocol processing applications including without limitation web browser clients 104, and data processing centers 105 managing one or more common database systems. It would be apparent to an artisan of ordinary skill in the art that the APPS 102 as described herein can be utilized for any protocol processing application.

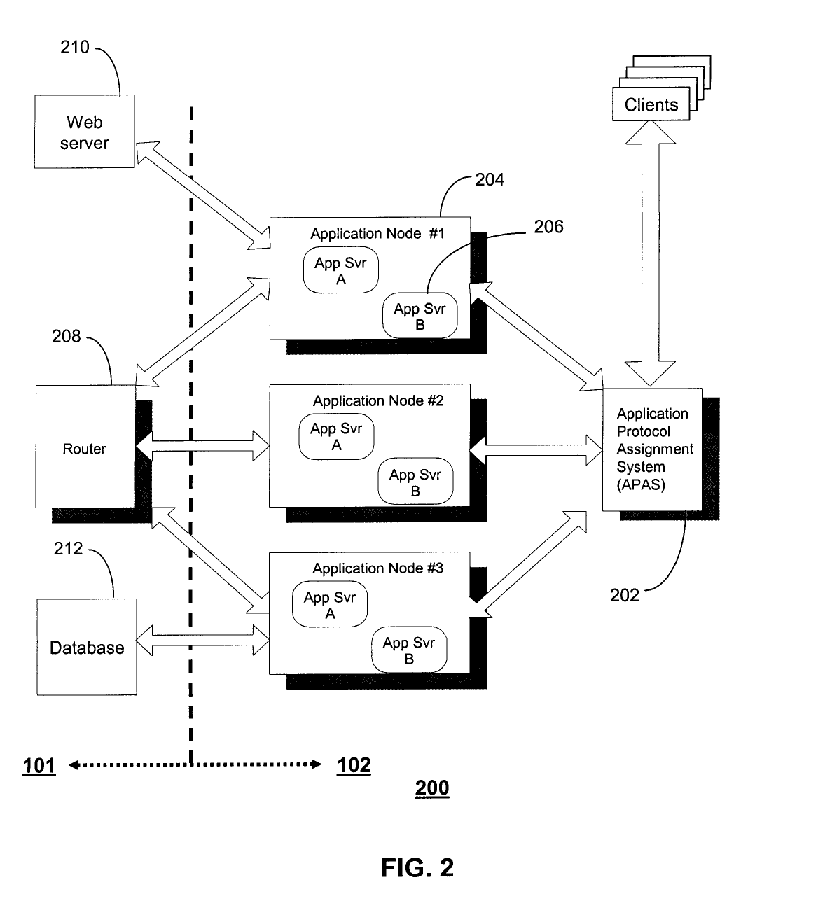

FIG. 2 depicts exemplary embodiments of the APPS 102 for managing transport of signaling information by a router 208 of the IP network 101. In this illustration, the APPS 102 can comprise an Application Protocol Assignment System (APAS) 202 coupled to three application nodes 204 (utilizing common scalable hardware computing technology) each operating two application servers 206 (software servers) managed thereby for the purpose of processing application protocol requests associated with any application session such as a SIP request (e.g., establishing a VoIP service), an HTTP request (e.g., web page application), or a combination thereof (e.g., click-to-call that generates an HTTP form to set up a VoIP call). The APAS 202 can operate as a proxy server having a purpose (among others) to balance processing between the application servers 206 of application protocol requests generated by remote clients in a manner that avoids a system fault such as an CPU and/or memory overload condition. The APAS 202 can also operate on enterprise data applications including web servers 210 and database systems 212. From the foregoing examples it would be apparent to an artisan with ordinary skill in the art that the APAS 202 can operate with any back-end system such as an HTTP server, SIP server, database server, service-oriented architecture server, web services server, presence server, IMS server, instant messaging server, enterprise service bus, persistent messaging server, protocol router, or other present or next generation protocol application servers and processes.

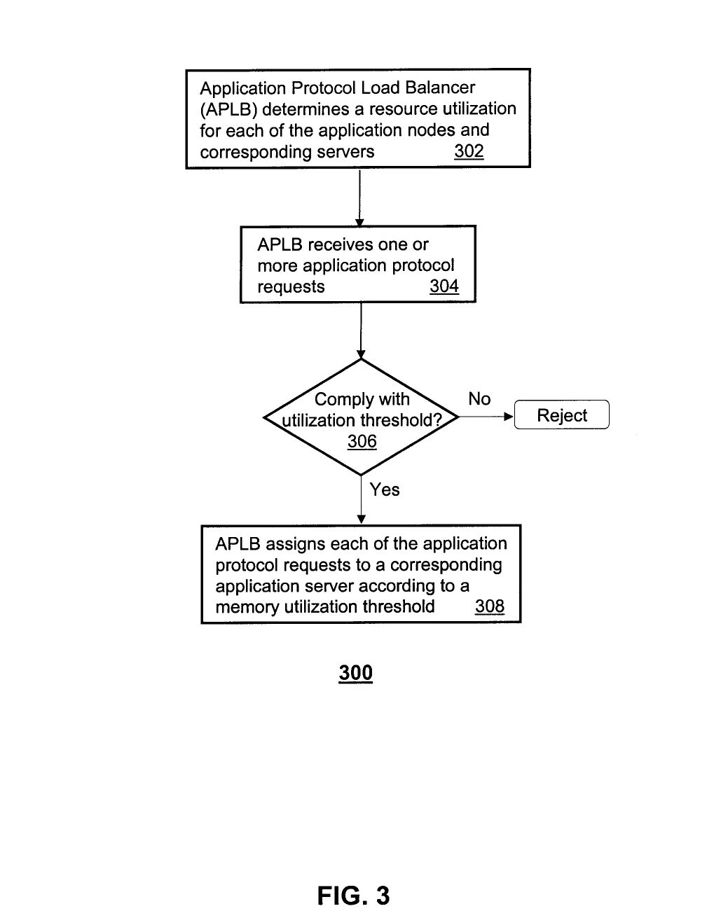

FIG. 3 depicts an exemplary method 300 operating in portions of the communication system 100. Method 300 begins with step 302 in which the APAS 202 determines resource utilization statistics for each of the application servers 206. The utilization statistics can include application memory statistics, memory recycling statistics, CPU utilization statistics (e.g., available CPU cycles), among other common hardware resource utilization factors. The utilization statistics can indicate to the APAS 202 whether computing resources (e.g., CPU utilization) of the application servers 206 will be capable of processing an incoming application protocol request with a minimal probability for a computing fault.

In this step, the APAS 202 can be programmed, for example, to determine the number of SIP sessions, HTTP sessions, and average amount of application memory consumed for each SIP and HTTP session, respectively. The APAS 202 can also monitor the amount of free application memory for each of the aforementioned sessions as well as the amount of memory recycling taking place for each session. The APAS 202 can further apply common hysteresis techniques to determine an appropriate resource utilization threshold for each of the application servers 206 to adequately process application protocol requests in most data traffic conditions including sudden traffic bursts in the communication system 100. To perform load balancing between the application servers 206, the APAS 202 can also apply common statistical analysis techniques such as linear regression to determine the assignments for incoming application protocol requests.

For illustration purposes, each of the application servers 206 can operate in a virtual machine such as a Java Virtual Machine (JVM) engine. A JVM's heap memory stores objects created by an executing Java program at run time. An application commonly referred to as a “garbage collector” manages utilization of heap memory. The garbage collector represents a process for recycling heap memory when an object is no longer referenced by the Java program. The recycled memory can be used for new objects created by the Java program. In addition to freeing objects, a garbage collector can reduce heap fragmentation. It will be appreciated by an artisan with ordinary skill in the art that any suitable programming system for processing application requests and any garbage collection application for managing heap memory can also be applied to the present disclosure.

It can be shown that as the average available heap memory of an application server 206 diminishes significantly (e.g., less than 10%) the CPU utilization rises to at or near its maximum utilization for periods of time. Forwarding a application request received by the APAS 202 in step 304 to an application server 206 operating under such conditions can cause a server failure, or an extremely high latency in communication services (especially real-time services such as VoIP) which can be undesirable to customers utilizing the IMS services of the communication system 100.

With knowledge of the resource utilization statistics for each application server 206, the APAS 202 can be programmed to compare in step 306 the resource utilization statistics to the aforementioned utilization threshold to determine which application servers 206 can readily handle an incoming application request without generating a fault condition. The utilization threshold can represent, for example, a heap memory utilization of not more than 60%. That is, an average 40% of heap memory must be available in order for an application server 208 to be assigned processing of an incoming application request. The utilization threshold can also represent an application memory threshold as well as a CPU utilization threshold to add further assurance that the application protocol request will be processed by the application server 206. These thresholds can apply hysteresis principles to address anomalous traffic conditions in the communication system 100.

If none of the application servers 206 can comply with the aforementioned utilization threshold, the APAS 202 can reject said requests. If, on the other hand, one or more application servers 206 satisfy the utilization threshold, then the APAS 202 generate an assignment for each of the application protocol requests and delivers in step 308 said assignments to the application servers 206 based on the applications servers 208 having adequate utilization statistics for processing said requests.

As noted earlier, the aforementioned assignment can be used by the APAS 202 to achieve a load balancing objective. It can also be used to achieve a Quality of Service (QoS) objective. The load balancing objective can be applied on an individual basis or collectively. That is, load balancing can be applied to each application server 206 or collectively as a cluster based on the regression technique previously mentioned or other suitable common load balancing techniques. Common QoS techniques can also be applied to said assignments to satisfy, for example, Service Level Agreements (SLAs) for specific customers and/or to provide a general QoS standard for all users of the communication system 100. With the application of method 300, the application servers 206 can manage the workload presented to them and readily handle burst traffic in the IP network 101.

Upon reviewing the aforementioned embodiments, it would be evident to an artisan with ordinary skill in the art that said embodiments can be modified, reduced, or enhanced without departing from the scope and spirit of the claims described below. For example, although the APAS 202 and the application nodes 204 are illustrated in FIG. 2 as independent computing systems, said systems can be integrated into one scalable hardware system. This is but one example of several modifications that can be applied to the present disclosure without departing from the scope of the claims stated below. Accordingly, the reader is directed to the claims section for a fuller understanding of the breadth and scope of the present disclosure.

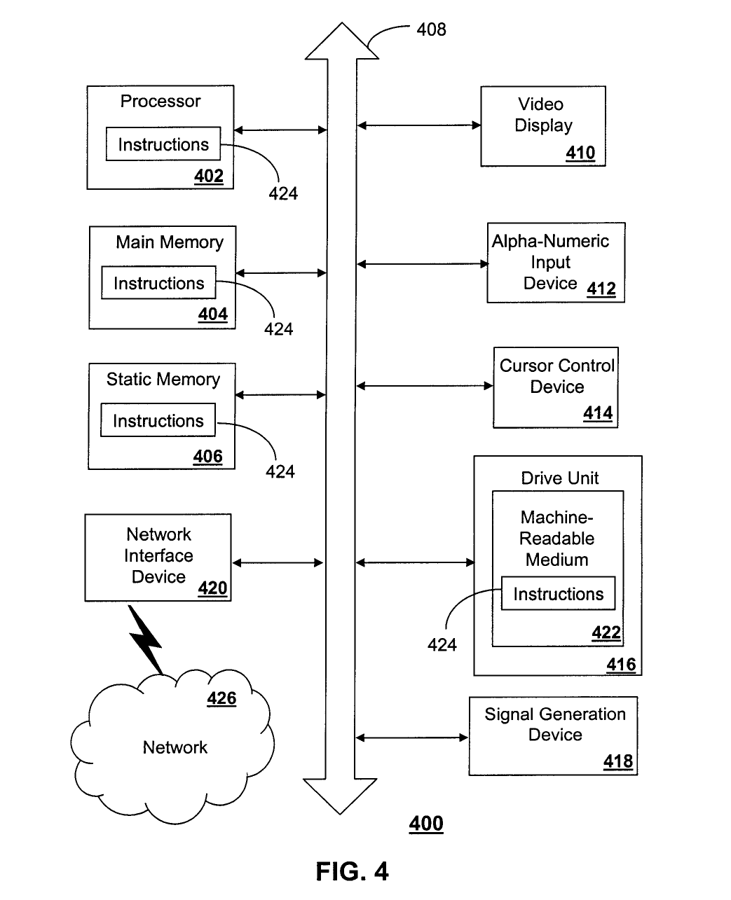

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU), or both, a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated above. The instructions 424 may also reside, completely or at least partially, within the main memory 404, the static memory 406, and/or within the processor 402 during execution thereof by the computer system 400. The main memory 404 and the processor 402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations including, but not limited to, distributed processing or component/object distributed processing, parallel processing, or virtual machine processing can also be constructed to implement the methods described herein.

The present disclosure contemplates a machine readable medium containing instructions 424, or which receives and executes instructions 424 from a propagated signal so that a device connected to a network environment 426 can send or receive voice, video or data, and communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in an Application Protocol Assignment System (APAS), comprising computer instructions for:
determining a memory utilization for each of a plurality of application servers;
receiving one or more application protocol requests; and
assigning each of the one or more application protocol requests to a select one or more of the plurality of application servers according to their respective memory utilization.

2. The storage medium of claim 1, wherein the memory utilization comprises a utilization of heap memory, and wherein the storage medium comprises computer instructions for determining the utilization of heap memory by each of the plurality of application servers.

3. The storage medium of claim 2, wherein the utilization of heap memory is a function of memory recycling taking place at each of the plurality of application servers.

4. The storage medium of claim 1, wherein at least one of the plurality of application servers manages at least one application protocol transaction operating on a Java Virtual Machine (JVM) engine.

5. The storage medium of claim 1, wherein the memory utilization comprises at least one among an application memory utilization threshold, and a memory recycling threshold, and wherein the storage medium comprises computer instructions for assigning each of the one or more application protocol requests to the select one or more of the plurality of application servers according to at least one among the application memory utilization threshold, and the memory recycling threshold.

6. The storage medium of claim 1, comprising computer instructions for choosing the select one or more of the plurality of application servers according to a load balancing objective determined from the memory utilization and a Central Processing Unit (CPU) utilization of each of the application servers.

7. The storage medium of claim 1, wherein the one or more application protocol requests are associated with an application session.

8. The storage medium of claim 7, wherein the application session comprises at least one among a Session Initiation Protocol (SIP) session, a Hyper Text Transfer Protocol (HTTP) session, and an IP Multimedia Session (IMS) session.

9. The storage medium of claim 1, wherein each of the one or more application protocol requests corresponds to at least one among a web page service, a a Voice over IP (VoIP) service, a web service, a service-oriented architecture service, a persistent messaging service, a presence service, an instant messaging service, a database service, an HTTP service, user client request, enterprise service bus service, and combinations thereof.

10. An Application Protocol Assignment System (APAS), comprising a controller element that assigns each of one or more application protocol requests to a select one or more of a plurality of application servers according to a memory utilization of each of the plurality of application servers.

11. The APAS of claim 10, wherein the memory utilization comprises a utilization of heap memory, and wherein the controller element determines the utilization of heap memory by each of the plurality of application servers.

12. The APAS of claim 11, wherein the utilization of heap memory is a function of memory recycling taking place at each of the plurality of application servers.

13. The APAS of claim 10, wherein at least one of the plurality of application servers manages at least one application protocol transaction operating in a virtual machine.

14. The APAS of claim 10, wherein the controller element assigns each of the one or more application protocol requests to the select one or more of the plurality of application servers according to a memory utilization threshold.

15. The APAS of claim 10, wherein the controller element chooses the select one or more of the plurality of application servers according to a load balancing objective determined from the memory utilization measured for of each of the plurality of application servers.

16. The APAS of claim 10, wherein the one or more application protocol requests are associated with at least one among a Session Initiation Protocol (SIP) session, a Hyper Text Transfer Protocol (HTTP) session, and an IP Multimedia Session (IMS) session, and wherein the controller element performs the assignment according to a Quality of Service (QoS) objective.

17. The APAS of claim 10, wherein each of the one or more application protocol requests corresponds to an application session.

18. A processing node, comprising a controller element that assigns one or more application protocol requests to one or more application servers according to a memory utilization determination for each of the one or more application servers.

19. The processing node of claim 18, wherein the processing node corresponds to one among a proxy node, an application node, and a combination thereof.

20. The processing node of claim 18, wherein the controller element:
supplies an Application Protocol Assignment System (APAS) memory utilization data for each of the one or more application servers, and
receives the assignment for each of the one or more application protocol requests from the APAS which determines said assignment according to a comparison of the memory utilization of each of the one or more application servers to a memory utilization threshold.
